(19) United States
(12) Patent Application Publication
(10) Pub. No.: US 2017/0129750 A1
(43) Pub. Date: May 11, 2017

(54) CRANE ATTACHMENT COMPRISING A LASER POINTER

(71) Applicant: BORÇELÍK ÇELÍK SANAYI TÍCARET ANONÍM SÍRKETÍ, Bursa (TR)

(72) Inventor: Mevlut Emrah SUSUZLU, Bursa (TR)

(73) Assignee: BORÇELÍK ÇELÍK SANAYI TÍCARET ANONÍM SÍRKETÍ, Bursa (TR)

(21) Appl. No.: 15/112,243

(22) PCT Filed: Jul. 20, 2015
(86) PCT No.: PCT/TR2015/050039

§ 371 Date: Jul. 18, 2016

(30) Foreign Application Priority Data
Jul. 21, 2014 (TR) 2014/08602

(51) Int. Cl. B66C 13/16; B66C 1/42

(52) U.S. Cl. CPC B66C 13/16; B66C 1/42

(57) ABSTRACT

A crane attachment having movable arms and a slide which embeds the lateral linear motion of the arms, the attachment having a laser pointer which allows the projection of the crane attachment to be marked lineally on the ground, allowing the crane operator to see the exact point where s/he will unload the material, and the material to be placed.

### TECHNICAL FIELD

The present invention is related to a crane used for transporting the materials from one place to another and stocking the same and to the attachments of these cranes.

The present invention is related to a crane attachment integrated with a laser pointer which allows the projection of the crane apparatus to be marked lineally on the ground, the crane operator to see the exact point where s/he will unload the material, and the material to be placed.

### PRIOR ART

The cranes are mechanical configurations which are used for material transportation, also for unloading the material being transported in a determined place and stocking the same. The operator who uses the crane determines the point where s/he will stop the material being transported in the air and lower the same with the accuracy only allowed by her/his experience. In general, it is not exactly known whether the material will fit into the determined place or not before unloading the material or approaching the same to the point where it will be unloaded.

The point where the material will be unloaded plays an important role in balanced loading and stocking. An unbalanced unloading/loading contains several risks such as damaging the material and occupational safety hazards. Likewise, when the crane operator is in a distant position from the point where the crane will perform unloading, these processes get more complicated.

In order to eliminate the technical problems stated above, the cranes are sometimes integrated with a camera pointed downwards. The operator can observe the point where the material will be placed by means of the camera. However, the points where the material will be unloaded cannot be perceived clearly only by means of the current camera systems.

During the patent search with respect to the crane attachments, an application numbered TR2011/01175 has been encountered. The abstract of this application is as follows: The present invention is related to a loading attachment which allows the attachments used for material loading in the heavy machinery (tractors, cranes, front loaders, rear loaders, etc.) to be used as rigid and long-lasting structures without straining by embedding the movable fork part from plural points.

The application numbered TR2011/01178 is another application encountered. The abstract of this application is as follows: The present invention is related to a double-cylinder loading attachment which allows the attachments used for material loading in the heavy machinery (tractors, cranes, front loaders, rear loaders, etc.) to be used as rigid and long-lasting structures without straining by embedding the movable fork part from double points.

### BRIEF DESCRIPTION OF THE INVENTION

The object of the invention is to present diverse technical properties introducing a new development in this technical field differently from the crane attachments of the state of the art.

An object of the invention is, unlike the crane attachments of the state of the art, to enable the crane operator to clearly see and perceive the point where s/he will unload the material by means of the laser pointer installed to both movable sides of the crane attachment.

An object of the invention is to mark the projection of the crane apparatus lineally on the ground thanks to the laser pointer integrated to the crane attachment.

Another object of the invention is to make sure that the product or the material to be lowered is unloaded at the right point, thanks to the laser pointer integrated to the crane attachment.

Another object of the invention is to provide occupational safety, product and equipment safety, thanks to the laser pointer integrated to the crane attachment.

Another object of the invention is to shorten the decision-making time consumed by the crane operator and to avoid the inconvenience and labor loss caused in the event that the material needs to be lifted and re-placed at the right point after an incorrect operation, thanks to the laser pointer. The invention aims to increase the operational efficiency thereby.

Yet another object of the invention is to get attention of the operators present at the immediate environment (at site) and thus to make them get away from the unloading point when the laser marks the unloading point. This is another property of the invention which enhances the occupational safety.

An object of the invention is to activate the lasers by means of the on/off button next to the operator only when the crane operator wishes so. In this manner, the laser is operated only during the unloading process. Hence, not only the service life of the laser is increased but also the possibility and duration of laser exposure of the operators working at the immediate environment are reduced.

A different object of the invention is to ensure that the lasers are activated automatically (without pushing the on/off button) when the unloading button of the crane is pushed.

### FIGURES TO FACILITATE THE UNDERSTANDING OF THE INVENTION

FIG. 1 is the two-dimensional front view of the laser pointer of the invention when integrated to the crane attachment.

### PART NUMERALS

100-Crane attachment
101-Movable arms
102-Slide
200-Laser pointer
201-Laser source
202-Anti-vibration member
203-Connecting clips
204-Button
205-Connection members
Y-Lateral sections
X-Vertical axis

### DETAILED DESCRIPTION OF THE INVENTION

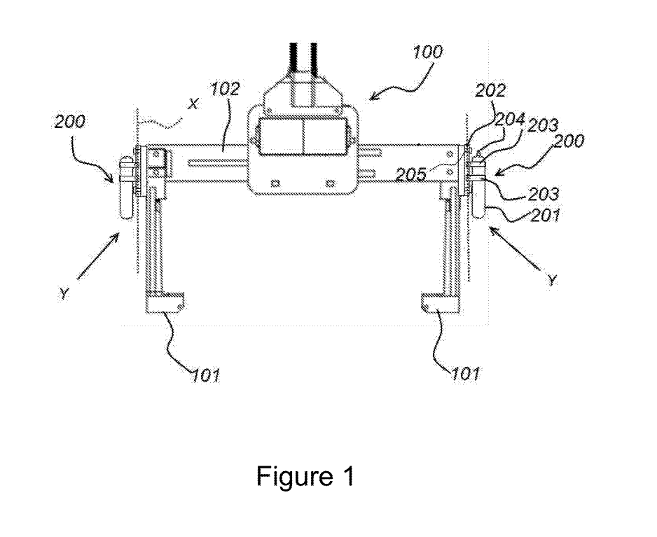

FIG. 1 illustrates the view of the crane attachment (100) comprising movable arms (101) and a slide (102) which embeds the lateral linear motion of said arms. A laser pointer (200) is integrated for allowing the projection of said crane attachment (100) to be marked lineally on the ground, the crane operator to see the exact point where s/he will unload the material, and the material to be placed.

FIG. 1 illustrates a laser source (201) adapted to the lateral sections (Y) of the crane attachment (100) in the vertical axis (X). An anti-vibration member (202) is located between the laser source (201) and the slide (102) body by means of the connection members (205). Likewise, connecting clips (203) are provided which secure said laser source (201) to the anti-vibration member (202).

The laser source (201) which is secured to the crane attachment (100) by means of the connecting clips (203) makes the required marking at the projection of the crane attachment (100) when it is activated with an on/off button (204) available next to the crane operator. The anti-vibration member (202), on the other hand, prevents the laser source (201) from being affected by the vibrations. Moreover, it prolongs the service life of the laser source (201). And, the on/off button (204) ensures that the laser source (201) is activated only when needed.

1. A crane attachment comprising movable arms and a slide which embeds the lateral linear motion of said arms, characterized in comprising a laser pointer which is integrated to the crane attachment and allows the crane operator to see the exact point where s/he will unload the material, and the material to be placed.

2. The crane attachment as in claim 1, characterized in comprising a laser source adapted to the lateral sections of said crane attachment in the vertical axis.

3. The crane attachment as in claim 1, characterized in comprising an anti-vibration member which is located between said laser source and the slide and secured by means of the connection members.

4. The crane attachment as in claim 1, characterized in comprising connecting clips which secure said laser source to said anti-vibration member.

5. The crane attachment as in claim 1, characterized in that said laser source comprises an on/off button.
